(19) United States
(12) Patent Application Publication
(10) Pub. No.: US 2012/0281130 A1
(43) Pub. Date: Nov. 8, 2012

(54) IMAGE PICKUP DEVICE

(75) Inventors: Keisuke Kudo, Kawasaki-shi (JP); Sogo Kuroiwa, Kawasaki-shi (JP)

(73) Assignee: CANON KABUSHIKI KAISHA, Tokyo (JP)

(21) Appl. No.: 13/554,865

(22) Filed: Jul. 20, 2012

Related U.S. Application Data
(63) Continuation of application No. PCT/JP2012/057456, filed on Mar. 23, 2012.

(30) Foreign Application Priority Data
Mar. 25, 2011 (JP) 2011-067813

(51) Int. Cl. H04N 5/232; H04N 5/222

(52) U.S. Cl. 348/333.08; 348/E05.022; 348/E05.045

(57) ABSTRACT

The image pickup device includes display control means that controls display means that is capable of displaying a live view, and control means that drives and controls a focus lens in the correction mode on the basis of the second focusing information or corrected first focusing information, which is first focusing information that has been corrected with a correction value for the first focusing information, the correction value being calculated so as to correspond to a difference between the first focusing information and the second focusing information, the control means restarting displaying of the live view on the display means, the displaying of the live view having been interrupted in the correction mode.

### CROSS-REFERENCE TO RELATED APPLICATIONS

This application is a Continuation of International Patent Application No. PCT/JP2012/057456, filed Mar. 23, 2012, which claims the benefit of Japanese Patent Application No. 2011-067813, filed Mar. 25, 2011, both of which are hereby incorporated by reference herein in their entirety.

### TECHNICAL FIELD

The present invention relates to an image pickup device that has a function for correcting focusing information of autofocus means employing a phase difference system, such as a single-lens reflex camera.

### BACKGROUND ART

To date, there has been a case where, with usage of a single-lens reflex camera that performs focusing using phase-difference AF, an in-focus position changes due to the durability of a lens or a camera body, and the focusing accuracy deteriorates as compared with that at the time soon after the camera is purchased.

With regard to the lens, a case is conceivable where a stop position of the lens, which is supposed to be driven to an accurate in-focus position, is shifted by an occurrence of looseness attributable to the durability.

With regard to the camera body, a case is conceivable where an AF sensor determines a position that is away from an accurate in-focus position as being the in-focus position because an angle of a mirror has changed during driving of the mirror and thus the direction of light incident on the AF sensor has changed.

In the above cases, a user has no choice but to bring the camera to a service center and ask them to readjust the in-focus position in order to restore the in-focus position to its original state.

For the purpose of solving the above problem, PTL 1, for example, discloses a function with which an in-focus position obtained by using phase-difference AF can be automatically corrected by using a contrast system.

### CITATION LIST

### Patent Literature

PTL 1: Japanese Patent Laid-Open No. 2000-292684

According to PTL 1, however, it is not possible to confirm a focusing accuracy obtained after the user has corrected the in-focus position having been obtained by using phase-difference AF.

It is an object of the present invention to provide an image pickup device whose focusing accuracy obtained after a user has corrected a focusing state can be confirmed by the user when a correction value is calculated, with which the focusing information having been obtained by phase-difference-system autofocus means is corrected by using a contrast system.

### SUMMARY OF INVENTION

In order to achieve the above object, an image pickup device according to the present invention is an image pickup device that includes first autofocus means, which obtains first focusing information using a phase difference system, and second autofocus means, which obtains second focusing information using a contrast system, the image pickup device being capable of being set to a correction mode for the first focusing information, the image pickup device including display control means that controls display means that is capable of displaying a live view in which a photographed image is displayed, and control means that drives and controls a focus lens in the correction mode such that the focus lens enters a focused state using the second focusing information or corrected first focusing information, which is first focusing information that has been corrected with a correction value for the first focusing information, the correction value being calculated so as to correspond to a difference between the first focusing information and the second focusing information, the control means allowing the display control means to restart displaying the live view on the display means, the displaying of the live view having been interrupted in the correction mode.

Further features of the present invention will become apparent from the following description of exemplary embodiments with reference to the attached drawings.

### BRIEF DESCRIPTION OF DRAWINGS

FIG. 1 is a flowchart illustrating an AF calibration operation according to the present invention.

FIG. 2 illustrates a screen for starting an AF calibration mode.

FIG. 3 illustrates a screen displaying a live view for confirming a focusing state.

FIG. 4 is a flowchart illustrating another AF calibration operation.

FIG. 5 is a flowchart illustrating a correction-value changing operation according to the present invention.

FIG. 6 illustrates a screen displaying a live view for changing a correction value.

FIG. 7 is a sectional view of a schematic structure when mirrors face downward.

FIG. 8 is a sectional view of a schematic structure when mirrors face upward.

FIG. 9 is a flowchart illustrating another AF calibration operation.

### DESCRIPTION OF EMBODIMENTS

An embodiment of the present invention is described below.

### Embodiment

As an image pickup device according to the present invention, a digital single-lens reflex camera whose lens is replaceable will be described.

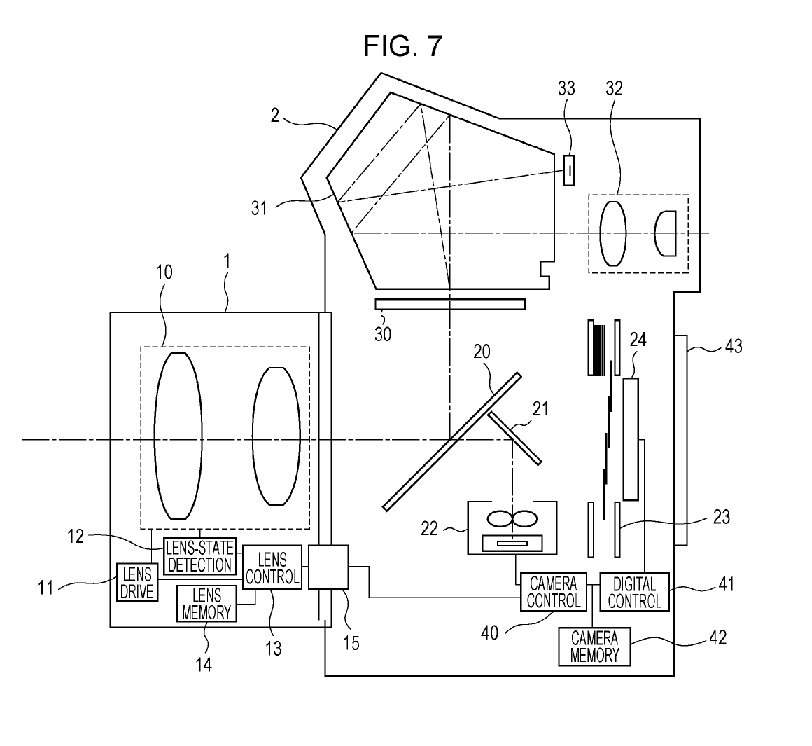

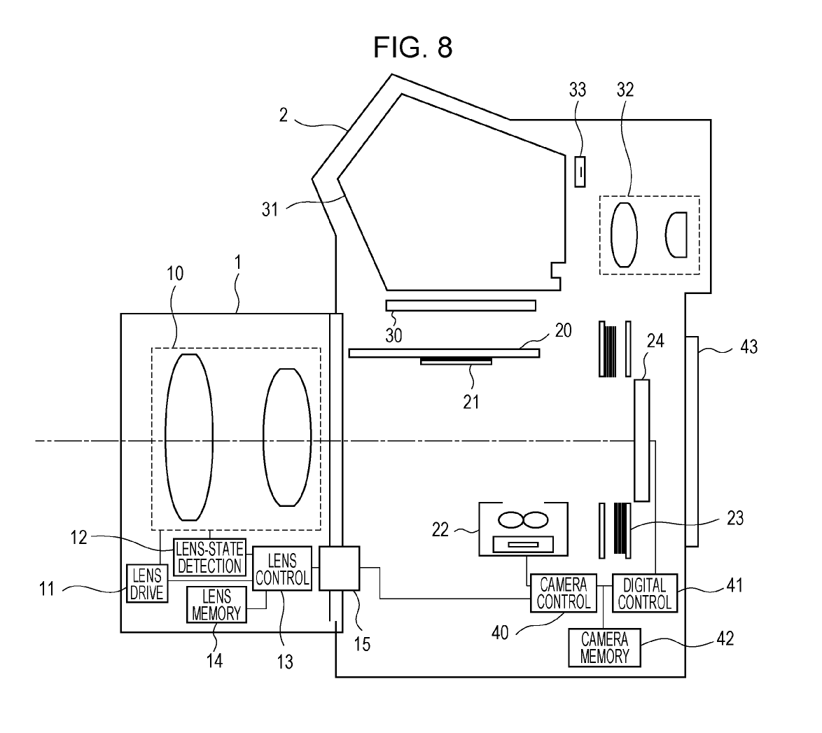

FIG. 7 and FIG. 8 are sectional views of a schematic structure of a digital single-lens reflex camera according to the embodiment.

An image-pickup optical system 10 housed in a lens 1 includes one or multiple lens units, and is capable of changing a focal length or a focus position by moving all or some of the lens units.

Lens driving means 11 is driving means that moves all or some of the lens units included in the image-pickup optical system 10 to adjust a focusing state.

Lens-state detecting means 12 is detecting means that detects a focal length, that is, a zooming position and a focus position, of the image-pickup optical system 10.

In addition, lens control means 13 is control means that controls the entirety of the lens 1 including lens memory means 14 constituted by a ROM or the like.

A connecting point 15 is a connecting point that is provided to the lens 1 and the camera body 2, and when the lens 1 and the camera body 2 are fitted to each other, various types of information are communicated through and power is supplied through the connecting point 15.

A main mirror 20 is constituted by a half mirror and is rotatable in accordance with the operation state of the camera. When a subject is observed through an optical viewfinder, the main mirror 20 is obliquely disposed on a photographing optical path and deflects a light flux from the lens 1 to guide the light flux to a viewfinder optical system, which will be described later (FIG. 7). In the case of photographing or displaying a live view, the main mirror 20 recedes from the photographing optical path to allow the light flux from the lens 1 to be guided to an image sensor 24, which will be described below (FIG. 8).

A sub-mirror 21 is rotated together with the main mirror 20. When the main mirror 20 is obliquely disposed on the photographing optical path, the sub-mirror 21 deflects the light flux that has been transmitted through the main mirror 20 to guide the light flux to an AF sensor 22, which will be described below (FIG. 7). In the case of photographing or displaying a live view, the sub-mirror 21 recedes from the photographing optical path by being rotated together with the main mirror 20 (FIG. 8).

The AF sensor 22 includes a secondary imaging lens, an area sensor including multiple CCDs or CMOS sensors, and the like. The AF sensor 22 is capable of detecting a focal point by using a publicly-known phase difference system.

A shutter 23 is used for controlling an incidence of a light flux from the lens 1 on an image sensor 24, which will be described below. The shutter 23 is normally in a closed state (FIG. 7), and enters an open state at the time of photographing and displaying a live view (FIG. 8).

The image sensor 24 includes a CMOS image sensor and a peripheral circuit of the CMOS image sensor.

A focusing screen 30 is disposed on a primary imaging area for the lens 1. The focusing screen 30 has a Fresnel lens (condenser lens) on an incident side, and a subject image (viewfinder image) is formed on an emergent side of the focusing screen 30. A pentaprism 31 is used to change a viewfinder optical path, and converts the subject image that has been formed on the emergent surface of the focusing screen 30 into an erect image.

An eye lens 32 is configured such that a diopter thereof is adjustable to the vision of a user at the time when the user sees through the viewfinder. Here, an optical system including the focusing screen 30, the pentaprism 31, and the eye lens 32 is referred to as a viewfinder optical system.

An AE sensor 33 is constituted by photodiodes that correspond to multisegment zones in an image pickup area, and measures a brightness of the subject image that has been formed on the emergent surface of the focusing screen 30.

Camera control means 40 controls the camera body 2 as well as the entirety of the camera including the lens 1. A microcomputer, for example, is adopted as the camera control means 40. The AF sensor 22 and the camera control means 40 constitute a first autofocus means (focal-point detection means) that obtains first focusing information by the phase difference system.

Digital control means 41 performs various control operations of image data, and a memory controller, for example, is adopted as the digital control means 41. The digital control means 41 can include contrast-system autofocus means (focal-point detection means), which detects a contrast of an image photographed by the image sensor 24 and determines in-focus focus position (referred to as an in-focus position, below) using a contrast evaluation value. The digital control means 41 constitutes second autofocus means (focal-point detection means) that obtains second focusing information by using a contrast system.

The camera memory means 42 stores settings used for performing various control operations, adjustment data, and the like, and a flash ROM is adopted as the camera memory means 42.

A liquid crystal monitor 43 displays a photographed image or various types of photographing information. The liquid crystal monitor 43 represents display means that displays a live view for confirmation of a focusing status when set to an AF calibration mode (focusing-information correcting mode).

Although not illustrated in FIG. 7 and FIG. 8, the liquid crystal monitor 43 is provided with a SET button and a cancel button. When the SET button is pressed while being displayed on the liquid crystal monitor 43, it is possible to perform operations, such as determination or selection. When, on the other hand, the cancel button is pressed while being displayed on the liquid crystal monitor 43, it is possible to perform operations, such as to return to a previous state or to finish a specific mode.

The digital control means 41 includes computing means that calculates a correction value based on a difference between two outputs, one of which is obtained by using a contrast system and the other one of which is operated by the camera control means 40 using a phase difference system on the basis of an output from the AF sensor 22. The difference calculated by the computing means is stored in the camera memory means 42 as the correction value.

The camera according to this embodiment can be set to an AF calibration mode in which the camera calculates and stores the above-described correction value.

Hereinbelow, a function for making a correction for phase-difference AF (AF calibration, below) will be described.

### (Method of Moving Lens to In-Focus Position Obtained After Correcting In-Focus Position Having Been Obtained by Phase Difference Detecting System)

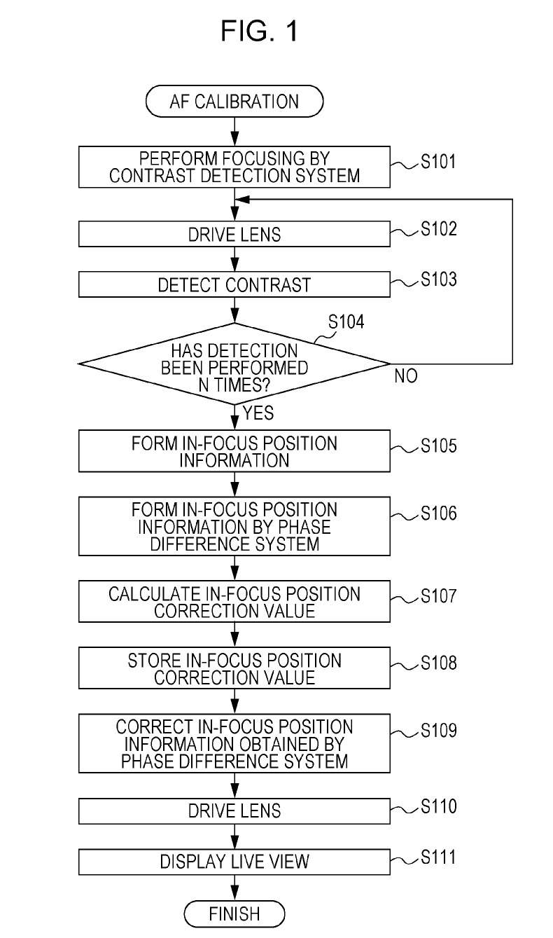

FIG. 1 is a flowchart illustrating an AF calibration operation according to the embodiment.

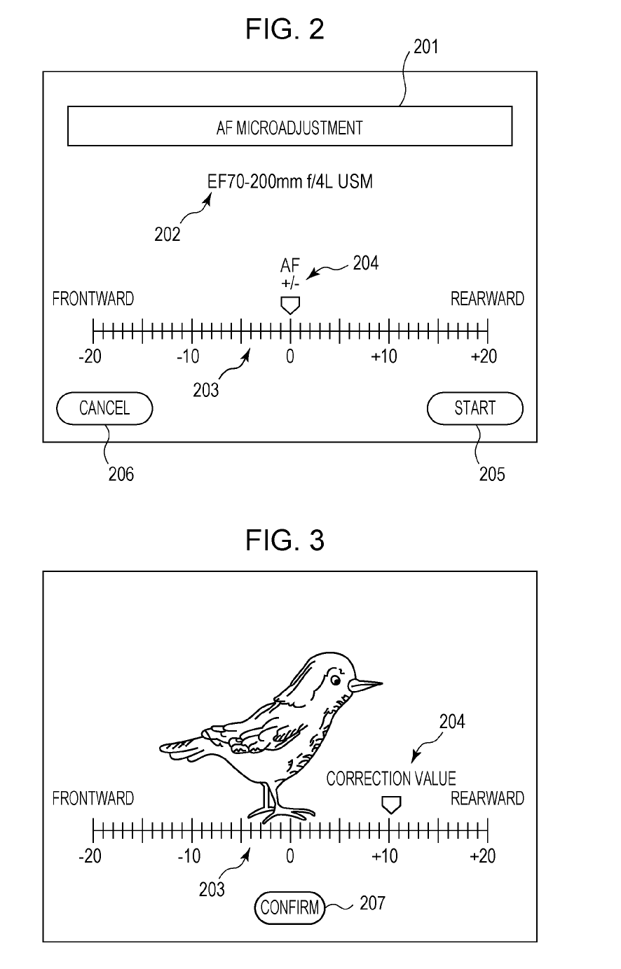

Before starting a flow, an operation to determine a subject is needed, first. After the subject is determined, an AF calibration is started. A start screen at this time is as illustrated in FIG. 2.

The AF calibration is started by an instruction of a user. While the camera is in the above-described AF calibration mode, the user presses a start button 205 illustrated in FIG. 2 to start the AF calibration. FIG. 2 illustrates a mode name display frame 201 that displays AF microadjustment, which is an alternative name for the AF calibration mode, a lens name 202, a calibration 203, a correction value index 204, and a cancel button 206.

In Step S101, a subject is focused on by using the contrast detection system (alternative name for the contrast system).

In Step S102, the camera control means 40 transmits a signal to the lens control means 13 to move a focus lens to a predetermined position via the lens driving means 11.

In Step S103, a contrast of an image signal obtained from the image sensor 24 is detected by the digital control means 41.

In Step S104, the slight movement of the focus lens in Step S102 and the contrast detection in Step S103 are repeated until a predetermined number N of times is reached.

In Step S105, the digital control means 41 determines a focus position, at which an image signal having a contrast highest among N detected results of contrasts is obtained, as an in-focus position, and transmits a signal to the camera control means 40. The camera control means 40 receives position information at this time from the lens-state detecting means 12 via the lens control means 13 and forms in-focus position information. In summary, a high contrast evaluation value that satisfies certain conditions is converted into a focus position, which is taken as an in-focus position.

In Step S106, the camera control means 40 causes the AF sensor 22 to detect a focal point by using phase-difference AF, and forms the in-focus position information by adding a value to the focus position information from the lens-state detecting means 12, the value being obtained by converting a result detected at this time, i.e., a focal-point shift amount (defocus amount), into an amount of driving of a focus lens in an in-focus direction.

In Step S107, the camera control means 40 causes the digital control means 41 to calculate an in-focus position correction value, which is a difference between the in-focus position information determined by the digital control means 41 as an in-focus position and the in-focus position information obtained from among the detected results of the AF sensor 22.

In Step S108, the in-focus position correction value calculated by the digital control means 41 is stored in the camera memory means 42.

In Step S109, the in-focus position information formed in Step S106 is corrected with the in-focus position correction value stored in the camera memory means 42.

In Step S110, the camera control means 40 transmits a signal to the lens control means 13 to move the focus lens to the in-focus position, which has been corrected in Step S109, via the lens driving means 11. In this step, an amount of shift of the focal point (defocus amount) obtained by using phase-difference AF is calculated, the amount of shift of the focal point (defocus amount) is corrected with the in-focus position correction value stored in the camera memory means 42, and the focus lens is moved in accordance with the corrected value. The calculation, the correction, and the movement are each performed at least twice. With these operations being performed twice or more, it is possible to eliminate a shift from a target position due to looseness of a driving member (gear, motor, or another component) of the focus lens.

In Step S111, displaying of the live view, which has been interrupted during the AF calibration mode, is restarted, so that a live view image is displayed on the liquid crystal monitor 43. Since the focus lens is moved in accordance with the in-focus position correction value and the moving of the focus lens is performed at least twice in Step S110, it is possible to display a live view that has a high focusing degree.

A screen displaying a live view at this time is as illustrated in FIG. 3. As the index 204 indicates the position of +10 in the example of FIG. 3, the correction value displayed on the screen is +10. Here, a user can confirm the correction value and the focusing accuracy corresponding to the correction value by seeing the live view image screen displayed on the liquid crystal monitor 43. FIG. 3 illustrates a confirmation button 207 that is displayed on the screen while the screen is displaying the live view, and when the user presses the confirmation button 207, the correction value is fixed.

The AF calibration is finished with these steps.

### (Method of Moving Lens to In-Focus Position Obtained by Using Contrast Detection System)

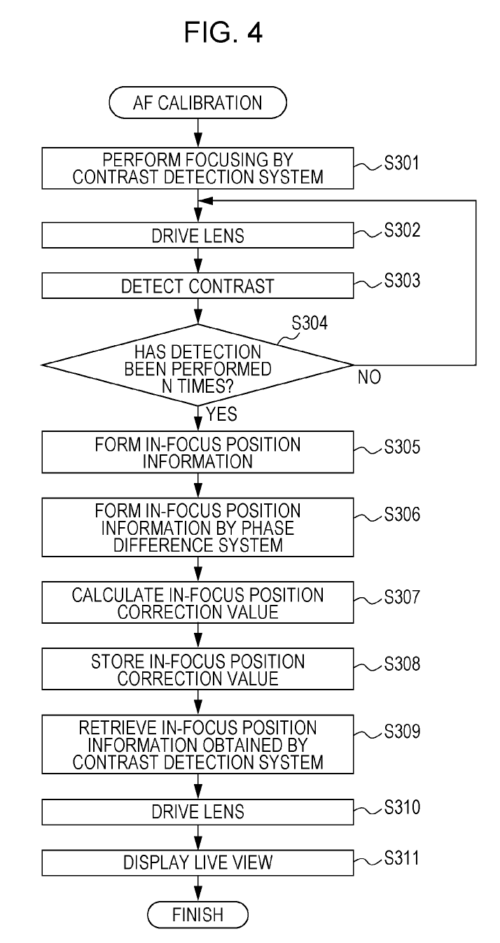

In Step S110, the focus lens is moved to a position obtained by correcting the in-focus position having been obtained by using the phase-difference AF. In this regard, the focus lens may be moved to an in-focus position obtained by using a contrast detection system. An AF calibration flow in that case is as illustrated in FIG. 4. The flow illustrated in FIG. 4 follows the flow illustrated in FIG. 1.

An in-focus position obtained by using a contrast detection system in Step S305 is stored in the camera memory means 42 or a RAM in advance and is retrieved in Step S309 in FIG. 4.

In Step S310, the camera control means 40 transmits a signal to the lens control means 13 to move the focus lens to the in-focus position, having been retrieved in Step S309, via the lens driving means 11.

Here, description has been given of a method in Step S310 where a lens is moved to the in-focus position obtained by using a contrast detection system. In this regard, since the AF calibration is performed to make a correction for the phase-difference AF, a method in Step S110 is preferable where the lens is moved to the in-focus position obtained by making a correction for the phase-difference AF. This is because, even though the lens is moved toward the in-focus position obtained by using a contrast detection system, the live view is displayed while the focusing degree is somewhat reduced compared with the case of the above-described example due to the looseness of a driving member (gear, motor, or another component) of the lens. However, the reduction of the focusing degree may be allowed since the live view display is visually recognized through a small rear monitor or a movable monitor, which is generally attached to a camera.

### (Method of Obtaining In-Focus Position by Using Phase-Difference Detection System After Bringing Lens Close to In-Focus Position Obtained by Using Contrast Detection System)

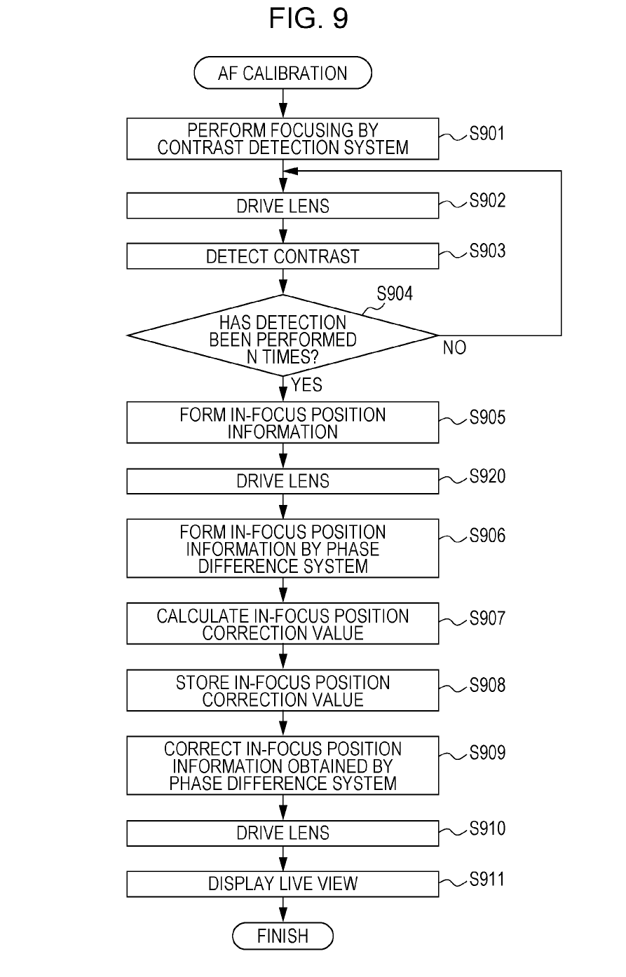

In Step 106 of FIG. 1, the in-focus position information is obtained by using a phase difference system after the contrasts have been detected and before the lens is driven. Here, the in-focus position information may be obtained by using a phase difference system after the lens is driven so as to come closer to the in-focus position in accordance with the in-focus position information having been obtained by using a contrast detection system in Step S105. The flow of the AF calibration in this case is as illustrated in FIG. 4. The flow in FIG. 9 follows the flow in FIG. 1.

The lens is driven so as to come closer to the in-focus position having been obtained by using a contrast detection system in Step S905 in accordance with the in-focus position information (Step S920). Then in Step S906, the in-focus position information is formed by using the phase difference system.

According to the flow illustrated in FIG. 9, detection of the in-focus position using the phase difference system can be performed with a high accuracy. This is because an image obtained at this time is less blurred than an image obtained at the time when driving of the lens for contrast detection is finished. Thus, multiple calculations of an amount of shift of the focal point (defocus amount) by using the phase-difference AF and multiple corrections of an amount of shift of the focal point (defocus amount), which have been made in Step S110 of the flow in FIG. 1, become unnecessary. The calculation and correction may of course be performed multiple times as illustrated in the flow of FIG. 1.

In this case, after the in-focus position information has been obtained by using a phase difference system in Step S920, the in-focus position information having been formed in Step S906 is corrected in Step S909 with the in-focus position correction value stored in the camera memory means 42. This step is performed similarly to Step S109 of FIG. 1.

In Step S910, in the same manner as in Step S110, the camera control means 40 transmits a signal to the lens control means 13 to move the focus lens to the in-focus position, having been corrected in Step S909, via the lens driving means 11.

### (Changing Correction Value by User)

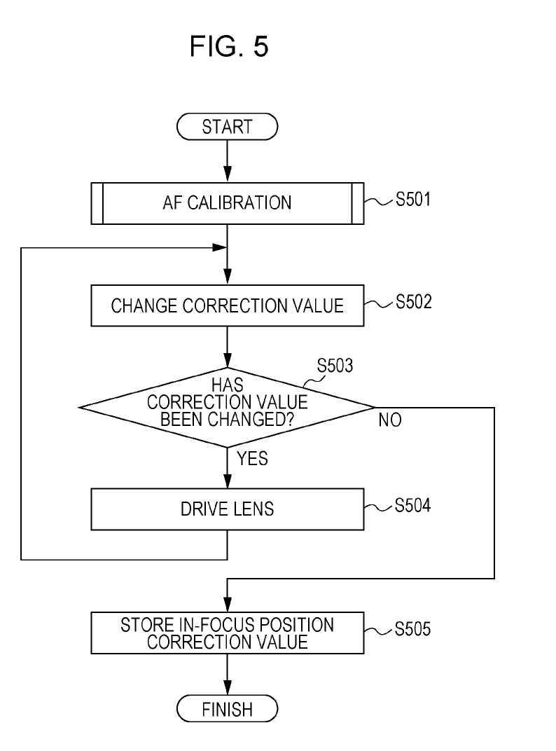

Next, a case where a user changes a correction value after the AF calibration has been performed will be described. FIG. 5 is a flowchart illustrating that a correction value can be changed by a user.

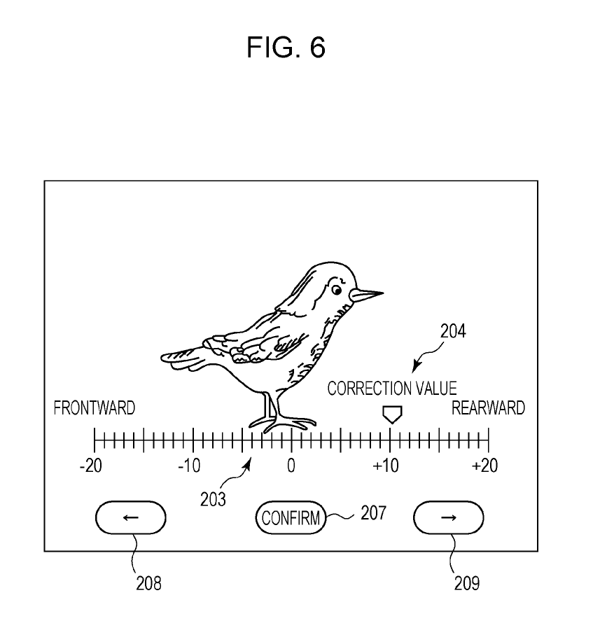

In Step S501, a series of steps of the AF calibration operation illustrated in FIG. 1 or FIG. 4 is performed. In this case, the screen that displays a live view in Step S111 or Step S311 is as illustrated in FIG. 6.

In Step S502, the user can change the correction value. The user changes the correction value in the front direction or the rear direction by pressing a correction-value changing button (frontward) 208 or a correction-value changing button (rearward) 209, which is displayed on the screen of FIG. 6. In the case where no change is needed, the user confirms the correction value by pressing the confirmation button 207. At this time, the user can change the correction value while confirming a subject image displayed as a live view, since the displaying of the live view is restarted in Step S111 of FIG. 1.

In Step S503, it is determined whether or not the correction value has been changed in Step S502. In the case where the correction value has been changed, the flow proceeds to Step S504. In the case where the correction value has not been changed, the flow proceeds to Step S505.

In Step S504, the camera control means 40 transmits a signal to the lens control means 13 in accordance with the amount of change of the correction value to move the focus lens via the lens driving means 11. In Step S505, the correction value is stored in the camera memory means 42.

In the above embodiment, the following effects can be obtained.

A user can confirm the accuracy of focusing performed by using the phase-difference AF after the AF calibration, by driving the lens to the in-focus position obtained by correcting the in-focus position having been obtained by using the phase-difference AF, and then by displaying an image at that time.

Further, since a user can change the correction value while confirming the focusing accuracy, the user can perform a correction for the phase-difference AF as intended.

Although means that includes the AF sensor 22 and the camera control means 40 is described as the first autofocus means employing the phase difference system, the present invention is not limited to this. Phase-difference autofocus means employing an image-pickup-surface phase difference system, in which focal-point detection pixels are arranged in a focal-point detection area on an image pickup surface of the image sensor 24, can also be employed as the first autofocus means.

The present invention is not limited to the above-described embodiment, and can be changed or modified in various manners without departing from the spirit or scope of the present invention. Thus, in order to make the scope of the present invention known to the public, the following claims are presented.

According to the present invention, a focusing accuracy obtained after a user has corrected a focusing state can be confirmed by the user when a correction value is calculated, with which the focusing information having been obtained by phase-difference-system autofocus means is corrected by using a contrast system.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An image pickup device that includes first autofocus means, which obtains first focusing information using a phase difference system, and second autofocus means, which obtains second focusing information using a contrast system, the image pickup device being capable of being set to a correction mode for the first focusing information, the image pickup device comprising:
display control means that controls display means that is capable of displaying a live view in which a photographed image is displayed; and
control means that drives and controls a focus lens in the correction mode such that the focus lens enters a focused state using the second focusing information or corrected first focusing information, which is first focusing information that has been corrected with a correction value for the first focusing information, the correction value being calculated so as to correspond to a difference between the first focusing information and the second focusing information, the control means allowing the display control means to restart displaying the live view on the display means, the displaying of the live view having been interrupted in the correction mode.

2. The image pickup device according to claim 1,
wherein the first focusing information is obtained by converting a defocus amount into a focus position, and
wherein the second focusing information is obtained by converting a contrast evaluation value into a focus position.

3. The image pickup device according to claim 1, wherein the display means displays the correction value on a screen displaying the live view.

4. The image pickup device according to claim 1, wherein the display means displays a confirmation button, with which the correction value is confirmed, on a screen displaying the live view.

5. The image pickup device according to claim 1, further comprising correction-value changing means with which the correction value is changed.

6. The image pickup device according to claim 5, wherein the display means displays a correction-value changing button, with which the correction value is changed, on a screen displaying the live view.
